(19) United States
(12) Patent Application Publication
(10) Pub. No.: US 2024/0037645 A1
(43) Pub. Date: Feb. 1, 2024

(54) Method, System, and Computer Program Product for Conducting Real-Time Auction Events Based on a Countdown Timer

(71) Applicant: MAC Discount, LLC, Butler, PA (US)

(72) Inventors: Shawn Allen, Pittsburgh, PA (US); Andrew Stewart, Wexford, PA (US)

(21) Appl. No.: 18/226,928

(22) Filed: Jul. 27, 2023

Related U.S. Application Data
(60) Provisional application No. 63/392,685, filed on Jul. 27, 2022.

(51) Int. Cl. G06Q 30/08; G06Q 30/0601

(52) U.S. Cl. CPC G06Q 30/08; G06Q 30/0635

(57) ABSTRACT

Methods, systems, and computer program products are provided for conducting real-time auction events based on a countdown timer. The method includes receiving product data associated with a product including a price of the product, generating a live auction event associated with the product, incrementally decreasing the price of the product based on a countdown timer, receiving a bid order request including bid data associated with a bid order for the product, the bid data including a bid price, a bid quantity, and a bid identifier, the bid identifier corresponding to a user account of a user, and fulfilling the bid order request based on the bid price of the bid order request.

### CROSS REFERENCE TO RELATED APPLICATION

This application claims the benefit of U.S. Provisional Patent Application No. 63/392,685, filed on Jul. 27, 2022, the disclosure of which is hereby incorporated by reference in its entirety.

### BACKGROUND

### 1. Field

This disclosure relates generally to real-time auction events and, in non-limiting embodiments, methods, systems, and computer program products for conducting real-time auction events based on a countdown timer.

### 2. Technical Considerations

An auction (e.g., auction event) may include a process of buying and/or selling goods (e.g., products) and/or services by offering up the goods and/or services for bids and selling the goods and/or services to the highest bidder. In some instances, auctions may be conducted in the form of ascending-bid auctions. Ascending-bid auctions may include participants (e.g., users, buyers, sellers, and/or the like) who may openly bid against one another, with each subsequent bid being higher (e.g., having a greater monetary value, a higher bid amount, a higher offer, and/or the like) than the previous bid. In some instances, the highest bid at a given time may be publicly displayed, such that every participant may be aware of the highest bid amount. In some instances, auctions (e.g., ascending-bid auctions) may offer up a single good and/or service at a given time, such that goods and/or services are sold individually (e.g., one good sold per auction event). Bulk goods (e.g., overstock goods, multiple quantities of a single type of good, and/or the like) may be offered up and/or sold individually in separate auction events.

However, ascending-bid auctions (e.g., ascending-bid auction events) may require a large amount of time and a large amount of resources (e.g., resources of one or more computing devices) to complete (e.g., successfully sell all goods and/or services associated with the auction event) each auction event in an ascending-bid auction that offers up bulk goods. Additionally, offering up and/or selling bulk goods individually may cause the bid price of the goods to fall (e.g., decrease) over time as participants become frustrated with a repetition of auction events that offer up and/or sell the same good. As the bid price falls, the participants intending to buy only a single good (e.g., a single good of the bulk goods) may leave the auction event after successfully buying one good, but participants intending to buy more than one good (e.g., more than one bulk good) may need to remain at the auction and/or may need to participate in multiple auction events to buy more than one good. Furthermore, as the bid prices of goods fall, sellers may receive less income (e.g., from falling bid prices over time) from selling bulk goods at auction events. Buyers may not be able to buy a desired quantity of bulk goods without spending a large amount of time participating in multiple auction events, thus requiring more time and resources (e.g., resources of one or more computing devices). In some instances, when an increasing number of participants are active at an auction event at a given time (e.g., participants participating in multiple auction events to buy bulk goods), more resources (e.g., resources of one or more computing devices) may be required to support the increasing number of participants.

### SUMMARY

Accordingly, it is an object of the present disclosure to provide methods, systems, and computer program products for conducting real-time auction events based on a countdown timer with incremental changes in the price of a product.

According to non-limiting embodiments, provided is a computer-implemented method for conducting a real-time auction event including receiving product data associated with a product, the product data including a quantity of the product equal to an initial quantity value and a price of the product equal to an initial price value. The method also includes generating a live auction event associated with the product, the live auction event including an auction identifier, a countdown timer, and the product data. The method further includes incrementally decreasing the price of the product based on the countdown timer. The price of the product is equal to a subsequent price value of a plurality of subsequent price values, wherein each subsequent price value of the plurality of subsequent price values is less than the initial price value. The method further includes receiving a bid order request including bid data associated with a bid order for the product, the bid data including a bid price, a bid quantity, and a bid identifier. The bid identifier corresponds to a user account of a user. The method further includes fulfilling the bid order request based on the bid data of the bid order request. The bid price matches at least one subsequent price value of the plurality of subsequent price values of the price of the product and the quantity of the product is decreased to a subsequent quantity value. The subsequent quantity value is equal to the initial quantity value minus the bid quantity.

In some non-limiting embodiments, the computer-implemented method further includes, in response to fulfilling the bid order request, pausing the countdown timer associated with the live auction event such that the price of the product does not incrementally decrease and the price of the product is equal to the bid price. The method also includes generating a temporary countdown timer associated with the at least one subsequent price value and the bid price including a time duration. The method further includes activating the temporary countdown timer associated with the at least one subsequent price value and the bid price. The price of the product does not incrementally decrease and the price of the product is equal to the bid price while the temporary countdown timer is active.

In some non-limiting embodiments, the computer-implemented method further includes terminating the live auction event when the quantity of the product is equal to a value of zero and/or the price of the product is equal to a value of one.

In some non-limiting embodiments, the computer-implemented method further includes receiving one or more additional bid order requests including additional bid prices and additional bid quantities. Each additional bid price of the one or more additional bid order requests is equal to the bid price. The method further includes fulfilling the one or more additional bid order requests. The subsequent quantity value is decreased by each additional bid quantity of the one or more additional bid order requests.

In some non-limiting embodiments, the computer-implemented method further includes, in response to the time duration of the temporary countdown timer lapsing, reactivating the countdown timer associated with the live auction event such that the price of the product resumes incrementally decreasing.

In some non-limiting embodiments, the computer-implemented method further includes terminating the live auction event when the quantity of the product is equal to a value of zero.

In some non-limiting embodiments, the computer-implemented method further includes generating invoice data associated with one or more invoices. The one or more invoices correspond to the bid order request and one or more corresponding additional bid order requests that are fulfilled. The method further includes transmitting each invoice of the one or more invoices to the user account of the user based on the bid identifier of the bid order request and the corresponding one or more additional bid order requests that are fulfilled.

In some non-limiting embodiments, fulfilling the bid order request includes determining that the bid price of the bid order request matches the at least one subsequent price value of the plurality of subsequent price values of the price of the product. Fulfilling the bid order request may further include transmitting a confirmation message to the user account of the user indicating that the bid order request corresponding to the user account of the user has been fulfilled.

In some non-limiting embodiments, the live auction event is conducted via a graphical user interface. The auction identifier, the countdown timer, and the product data are displayed via the graphical user interface.

According to non-limiting embodiments or aspects, provided is a system comprising: at least one processor programmed or configured to: receive product data associated with a product, the product data comprising a quantity of the product equal to an initial quantity value and a price of the product equal to an initial price value; generate a live auction event associated with the product, the live auction event comprising an auction identifier, a countdown timer, and the product data; incrementally decrease the price of the product based on the countdown timer, the price of the product is equal to a subsequent price value of a plurality of subsequent price values, wherein each subsequent price value of the plurality of subsequent price values is less than the initial price value; receive a bid order request comprising bid data associated with a bid order for the product, the bid data comprising a bid price, a bid quantity, and a bid identifier, the bid identifier corresponds to a user account of a user; and fulfill the bid order request based on the bid data of the bid order request, the bid price matches at least one subsequent price value of the plurality of subsequent price values of the price of the product, and the quantity of the product is decreased to a subsequent quantity value, the subsequent quantity value equal to the initial quantity value minus the bid quantity.

In non-limiting embodiments or aspects, the at least one processor is further programmed or configured to: in response to fulfilling the bid order request, pause the countdown timer associated with the live auction event such that the price of the product does not incrementally decrease and the price of the product is equal to the bid price; generate a temporary countdown timer associated with the at least one subsequent price value and the bid price comprising a time duration; and activate the temporary countdown timer associated with the at least one subsequent price value and the bid price, the price of the product does not incrementally decrease and the price of the product is equal to the bid price while the temporary countdown timer is active.

In non-limiting embodiments or aspects, the at least one processor is further programmed or configured to: terminate the live auction event when the quantity of the product is equal to a value of zero or the price of the product is equal to a value of one. In non-limiting embodiments or aspects, the at least one processor is further programmed or configured to: receive one or more additional bid order requests comprising additional bid prices and additional bid quantities, wherein each additional bid price of the one or more additional bid order requests is equal to the bid price; and fulfill the one or more additional bid order requests, the subsequent quantity value is decreased by each additional bid quantity of the one or more additional bid order requests.

In non-limiting embodiments or aspects, the at least one processor is further programmed or configured to: in response to the time duration of the temporary countdown timer lapsing, reactivating, with at least one processor, the countdown timer associated with the live auction event such that the price of the product resumes, incrementally decreasing. In non-limiting embodiments or aspects, wherein generating the live auction event associated with the product comprises: generate a pre-auction event associated with the product, the pre-auction event comprising the auction identifier and the product data; and publish the pre-auction event associated with the product, the pre-auction event is accessible to the user account of the user via a web-based user interface. In non-limiting embodiments or aspects, the at least one processor is further programmed or configured to: terminate the live auction event when the quantity of the product is equal to a value of zero.

According to non-limiting embodiments or aspects, provided is a computer program product comprising at least one non-transitory computer-readable medium including program instructions that, when executed by at least one processor, cause the at least one processor to: receive product data associated with a product, the product data comprising a quantity of the product equal to an initial quantity value and a price of the product equal to an initial price value; generate a live auction event associated with the product, the live auction event comprising an auction identifier, a countdown timer, and the product data; incrementally decrease the price of the product based on the countdown timer, the price of the product is equal to a subsequent price value of a plurality of subsequent price values, wherein each subsequent price value of the plurality of subsequent price values is less than the initial price value; receive a bid order request comprising bid data associated with a bid order for the product, the bid data comprising a bid price, a bid quantity, and a bid identifier, the bid identifier corresponds to a user account of a user; and fulfill the bid order request based on the bid data of the bid order request, the bid price matches at least one subsequent price value of the plurality of subsequent price values of the price of the product, and the quantity of the product is decreased to a subsequent quantity value, the subsequent quantity value equal to the initial quantity value minus the bid quantity.

Other non-limiting embodiments will be set forth in the following numbered clauses:

Clause 1: A computer-implemented method comprising: receiving, with at least one processor, product data associated with a product, the product data comprising a quantity of the product equal to an initial quantity value and a price of the product equal to an initial price value; generating, with at least one processor, a live auction event associated with the product, the live auction event comprising an auction identifier, a countdown timer, and the product data; incrementally decreasing, with at least one processor, the price of the product based on the countdown timer, wherein the price of the product is equal to a subsequent price value of a plurality of subsequent price values, wherein each subsequent price value of the plurality of subsequent price values is less than the initial price value; receiving, with at least one processor, a bid order request comprising bid data associated with a bid order for the product, the bid data comprising a bid price, a bid quantity, and a bid identifier, wherein the bid identifier corresponds to a user account of a user; and fulfilling, with at least one processor, the bid order request based on the bid data of the bid order request, wherein the bid price matches at least one subsequent price value of the plurality of subsequent price values of the price of the product and wherein the quantity of the product is decreased to a subsequent quantity value, the subsequent quantity value equal to the initial quantity value minus the bid quantity.

Clause 2: The computer-implemented method of clause 1, further comprising: in response to fulfilling the bid order request, pausing, with at least one processor, the countdown timer associated with the live auction event such that the price of the product does not incrementally decrease and the price of the product is equal to the bid price; generating, with at least one processor, a temporary countdown timer associated with the at least one subsequent price value and the bid price comprising a time duration; and activating, with at least one processor, the temporary countdown timer associated with the at least one subsequent price value and the bid price, wherein the price of the product does not incrementally decrease and the price of the product is equal to the bid price while the temporary countdown timer is active.

Clause 3: The computer-implemented method of clause 1 or 2, further comprising: terminating, with at least one processor, the live auction event when the quantity of the product is equal to a value of zero or the price of the product is equal to a value of one.

Clause 4: The computer-implemented method of any of clauses 1-3, further comprising: receiving, with at least one processor, one or more additional bid order requests comprising additional bid prices and additional bid quantities, wherein each additional bid price of the one or more additional bid order requests is equal to the bid price; and fulfilling, with at least one processor, the one or more additional bid order requests, wherein the subsequent quantity value is decreased by each additional bid quantity of the one or more additional bid order requests.

Clause 5: The computer-implemented method of any of clauses 1-4, further comprising: in response to the time duration of the temporary countdown timer lapsing, reactivating, with at least one processor, the countdown timer associated with the live auction event such that the price of the product resumes incrementally decreasing.

Clause 6: The computer-implemented method of any of clauses 1-5, wherein generating the live auction event associated with the product comprises: generating a pre-auction event associated with the product, the pre-auction event comprising the auction identifier and the product data; and publishing the pre-auction event associated with the product, wherein the pre-auction event is accessible to the user account of the user via a web-based user interface.

Clause 7: The computer-implemented method of any of clauses 1-6, further comprising: terminating the live auction event when the quantity of the product is equal to a value of zero.

Clause 8: The computer-implemented method of any of clauses 1-7, wherein the initial price value is a retail price associated with the product.

Clause 9: The computer-implemented method of any of clauses 1-8, further comprising: generating, with at least one processor, invoice data associated with one or more invoices, wherein the one or more invoices correspond to the bid order request and one or more corresponding additional bid order requests that are fulfilled; and transmitting, with at least one processor, each invoice of the one or more invoices to the user account of the user based on the bid identifier of the bid order request and the corresponding one or more additional bid order requests that are fulfilled.

Clause 10: The computer-implemented method of any of clauses 1-9, wherein fulfilling the bid order request comprises: determining that the bid price of the bid order request matches the at least one subsequent price value of the plurality of subsequent price values of the price of the product; and transmitting a confirmation message to the user account of the user indicating that the bid order request corresponding to the user account of the user has been fulfilled.

Clause 11: The computer-implemented method of any of clauses 1-10, wherein the live auction event is conducted via a graphical user interface, wherein the auction identifier, the countdown timer, and the product data are displayed via the graphical user interface.

Clause 12: A system comprising: at least one processor; and at least one non-transitory computer-readable medium storing instructions that, when executed by the at least one processor, cause the at least one processor to perform the method of any one of clauses 1-11.

Clause 13: A computer program product comprising at least one non-transitory computer-readable medium including program instructions that, when executed by at least one processor, cause the at least one processor to perform the method of any one of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for conducting real-time auction events based on a countdown timer according to some non-limiting embodiments;

FIG. 2 is a flow diagram for a method of conducting real-time auction events based on a countdown timer according to some non-limiting embodiments;

FIG. 3 is a diagram of an exemplary environment in which methods, systems, and/or computer program products, described herein, may be implemented according to some non-limiting embodiments;

FIG. 4 is a schematic diagram of example components of one or more devices of FIG. 1 and/or FIG. 3 according to some non-limiting embodiments;

FIG. 5 is a graphical user interface showing an auction preview according to some non-limiting embodiments;

FIG. 6 is a graphical user interface showing a real-time auction event according to some non-limiting embodiments; and

FIG. 7 is a graphical user interface showing a sellout notice according to some non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings and appendix, and described in the following specification, are simply exemplary embodiments of the subject matter disclosed herein. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more primary account numbers (PANs), tokens, or other identifiers associated with a customer account (e.g., user account). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “merchant” may refer to an individual or entity that provides goods and/or services, or access to goods and/or services, to customers (e.g., users) based on a transaction, such as a payment transaction. The term “merchant” or “merchant system” may also refer to one or more computer systems operated by or on behalf of a merchant, such as a server computer executing one or more software applications.

As used herein, the terms “client” and “client device” may refer to one or more client-side devices or systems (e.g., remote from a transaction service provider) used to initiate or facilitate a transaction (e.g., a payment transaction). In some non-limiting embodiments, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network entity or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments of the disclosed subject matter are directed to methods, systems, and computer program products for real-time auctions, including, but not limited to, conducting real-time auction events based on a countdown timer. For example, non-limiting embodiments of the disclosed subject matter provide for receiving product data associated with a product (e.g., a good, a bulk good, and/or the like). The product data may include a quantity of the product equal to an initial quantity value and/or a price of the product equal to an initial price value (e.g., a first price value). Non-limiting embodiments directed to methods, systems, and computer program products may generate a live auction event (e.g., a software component, a software event, and/or the like) associated with the product. The live auction event may include an auction identifier, a countdown timer, and/or the product data. Non-limiting embodiments may incrementally decrease the price of the product based on the countdown timer (e.g., decrease the price in sync with the countdown timer). The price of the product may be equal to a subsequent price value (e.g., a second price value, third price value, fourth price value, and/or the like) of a plurality of subsequent price values (e.g., over time as the price is decreased). Each subsequent price value of the plurality of subsequent price values may be less than the initial price value. Non-limiting embodiments may receive a bid order request. The bid order request may include bid data associated with a bid order for the product. The bid data may include a bid price, a bid quantity, and/or a bid identifier. The bid identifier may correspond to a user account of a user. Non-limiting embodiments may fulfill (e.g., process, complete) the bid order request based on the bid price of the bid order request when the bid price matches at least one subsequent price value of the plurality of subsequent price values of the price of the product. The initial quantity value may be decreased by the bid quantity such that the quantity of the product is equal to a subsequent quantity value less than the initial quantity value.

Such non-limiting embodiments provide methods, systems, and computer program products that provide real-time auction events (e.g., live auction events) which reduce the resources (e.g., resources of one or more computing devices) required to successfully sell bulk goods in less time by executing real-time auction events that are conducted using a countdown timer. Each real-time auction event may allow users (e.g., participants and/or the like) to buy bulk goods in a reduced amount of time. Users of real-time auction events (e.g., a real-time auction system) may view current bid prices of goods in real-time via a graphical user interface with real-time feedback displaying the price of the product in a real-time auction event. Users may bid their desired price at which to buy a good once the good reaches the desired price in real-time during the live auction event, thus reducing the wait time when a user desires to purchase a single good from a plurality of goods (e.g., bulk goods). A reduced wait time for users may result in a reduced amount of resources consumed (e.g., resources of one or more computing devices) when conducting live auction events. A reduced amount of resources consumed may result because users (e.g., user devices of users) may be connected to live auction events (e.g., a real-time auction system) for less time due to the use of a countdown timer and real-time feedback displaying the price of the product and the time remaining on the countdown timer. Users may also view the price of a good (e.g., the product) in real-time via the graphical user interface as the price is updated corresponding to the countdown timer. In this way, non-limiting embodiments may reduce the amount of time required to fulfill (e.g., process, complete, and/or the like) bid orders received during a live auction event, and non-limiting embodiments may reduce the amount of resources (e.g., resources of one or more computing devices) to fulfill (e.g., successfully sell all goods and/or services associated with the auction event) and/or conduct each live auction event.

Additionally, non-limiting embodiments may improve the experience of a user (e.g., participant) by generating live auction events that offer up and/or sell bulk goods in real-time. Non-limiting embodiments may allow users to view live bid prices in real-time while a live auction event is active, and users may be able to view countdown timers (e.g., values displayed by countdown timers, values corresponding to countdown timers, and/or data corresponding to countdown timers) in real-time such that users may be aware of when (e.g., instantly and/or the like) bid prices may change (e.g., decrease). In this way, a live auction event offering up and/or selling bulk goods may allow sellers to receive higher bid prices from users without bid prices being driven up by other users. Users may receive an improved user experience by participating in a single live auction event that offers up and/or sells the same goods in bulk (e.g., bulk goods) rather than having to experience a repetition of auction events.

Non-limiting embodiments may allow users intending to buy only a single good (e.g., a single good of the bulk goods) an improved experience because the users may “name their price” for a single good, thus reducing the time required for a user to remain in an auction event as a participant. Users intending to buy more than one good (e.g., more than one bulk good) may receive an improved experience because the users may place bids (e.g., transmit bid order requests) associated with a quantity value, thus reducing the time required for a user (e.g., a user intending to buy bulk goods) to remain in an auction event as a participant. In this way, the number of users (e.g., participants) at an auction event that are active (e.g., participating in a live auction event, viewing a live auction event via a graphical user interface, connected to a live auction event, and/or the like) at a given time may be reduced and auction events (e.g., live auction events, real-time auction events, and/or the like) may be carried out in less time while requiring a reduced amount of resources (e.g., resources of one or more computing devices).

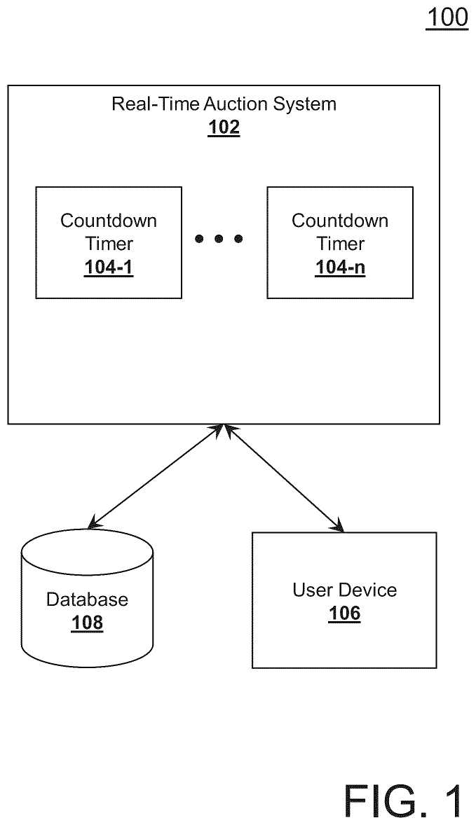

FIG. 1 depicts a system 100 for conducting real-time auction events based on a countdown timer according to some non-limiting embodiments. The system 100 may include real-time auction system 102, countdown timer 104, user device 106, and database 108. In some non-limiting embodiments, countdown timer 104, user device 106, and/or database 108 may be a component of (e.g., part of) real-time auction system 102. In some non-limiting embodiments, countdown timer 104, user device 106, and/or database 108 may be a separate (e.g., a separate system) from real-time auction system 102.

Real-time auction system 102 may include one or more devices capable of receiving information from and/or communicating information to countdown timer 104, user device 106, and/or database 108. For example, real-time auction system 102 may include a computing device, such as a server (e.g., a single server), a group of servers, and/or other like devices. In some non-limiting embodiments, real-time auction system 102 may include at least one processor (e.g., a multi-core processor). In some non-limiting embodiments, real-time auction system 102 may be in communication with a data storage device (e.g., database 108), which may be local or remote to real-time auction system 102. In some non-limiting embodiments, real-time auction system 102 may be capable of receiving information from, storing information in, communicating information to, or searching information stored in the data storage device. In some non-limiting embodiments, real-time auction system 102 may store and/or receive product data (e.g., data associated with a product description, data associated with a product price, data associated with a product quantity, and/or the like), as described herein.

In some non-limiting embodiments, real-time auction system 102 may include countdown timer 104-1 to countdown timer 104-n (e.g., a plurality of countdown timers, referred to individually as countdown timer 104 and collectively as countdown timers 104 where appropriate). Real-time auction system 102 may include countdown timer 104 implemented as a software component, a hardware component (e.g., hardware circuitry), or a combination of software and hardware. In some non-limiting embodiments, real-time auction system 102 may be separate and/or remote from countdown timer 104 and may communicate with countdown timer 104 via a communication interface over a network or the like.

Countdown timer 104 may include one or more devices capable of receiving information from and/or communicating information to real-time auction system 102, user device 106, and/or database 108. For example, countdown timer 104 may include a computing device, such as a server, a group of servers, and/or other like devices. In some non-limiting embodiments, countdown timer 104 may include a software application or function (e.g., a software component, a timer model, and/or the like) executed by a computing device, as described herein. For example, countdown timer 104 may include a software component implemented using one or more instructions (e.g., software instructions) of real-time auction system 102. Countdown timer 104 may be activated to count time in increments (e.g., increments of milliseconds, seconds, minutes, and/or the like) and/or paused such that countdown timer 104 is paused on a current time (e.g., a current time remaining, such as 30 seconds), counting down to zero (0) seconds. Countdown timer 104 may be paused such that countdown timer 104 is not elapsing (e.g., not counting time, stopped, and/or the like). In some non-limiting embodiments, when countdown timer 104 is paused, countdown timer 104 may still be capable of communicating (e.g., communicating data, communicating signals, and/or the like) to real-time auction system 102.

User device 106 may include one or more devices capable of receiving information from and/or communicating information to real-time auction system 102, countdown timer 104, and/or database 108. For example, user device 106 may include a computing device, such as a computer, a mobile device, a server, a group of servers, and/or other like devices. In some non-limiting embodiments, user device 106 may communicate bid data (e.g., bid data associated with a bid order) to real-time auction system 102, as described herein. In some non-limiting embodiments, user device 106 may receive outputs (e.g., confirmation messages, invoice data associated with one or more invoices, product data, data from countdown timer 104, and/or the like) from real-time auction system 102 and/or countdown timer 104, as described herein.

Database 108 may include one or more devices capable of receiving information from and/or communicating information to real-time auction system 102, countdown timer 104, and/or user device 106. For example, database 108 may include a computing device, such as a server, a group of servers, and/or other like devices. In some non-limiting embodiments, database 108 may be in communication with a data storage device, which may be local or remote to database 108. In some non-limiting embodiments, database 108 may be capable of receiving information from, storing information in, communicating information to, and/or searching information stored in the data storage device. In some non-limiting embodiments, database 108 may store product data, bid data (e.g., bid data associated with one or more bid orders), data from countdown timer 104 (e.g., timestamp data), and/or the like generated by real-time auction system 102, as described herein.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

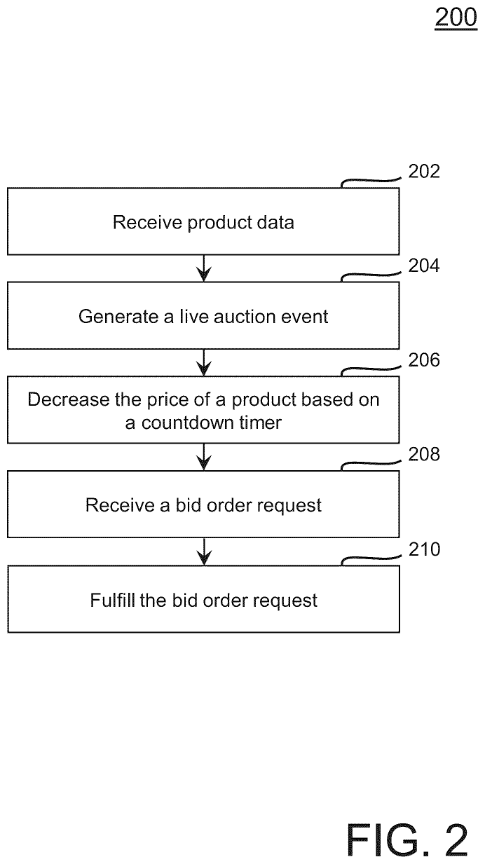

Referring now to FIG. 2, shown is a process 200 for conducting real-time auction events based on a countdown timer according to some non-limiting embodiments. The steps shown in FIG. 2 are for example purposes only. It will be appreciated that additional, fewer, different, and/or a different order of steps may be used in non-limiting embodiments. In some non-limiting embodiments, one or more of the steps shown in FIG. 2 may occur automatically in response to performance of a previous step.

As shown in FIG. 2, at step 202, process 200 may include receiving product data. For example, real-time auction system 102 may receive product data associated with a product from user device 106 and/or database 108. In some non-limiting embodiments, the product data may include a quantity of the product equal to an initial quantity value and a price of the product equal to an initial price value. For example, real-time auction system 102 may receive product data including a quantity of the product equal to an initial quantity value of one hundred (e.g., 100 units of the product and/or the like). Real-time auction system 102 may receive product data including a price of the product equal to an initial price value of $50 (e.g., $50 per unit of the product and/or the like).

As shown in FIG. 2, at step 204, process 200 may include generating a live auction event. For example, real-time auction system 102 may generate a live auction event associated with the product. In some non-limiting embodiments, the live auction event may include an auction identifier, a countdown timer (e.g., countdown timer 104), and the product data. For example, real-time auction system 102 may generate a live auction event including the product data. Real-time auction system 102 may generate a live auction event for the product including a quantity of the product equal to an initial quantity of 100 and a price of the product equal to an initial price of $50. In some non-limiting embodiments, generating the live auction event may include generating a webpage and/or structured data (e.g., such as XML, JavaScript Object Notation (JSON), and/or the like) based on a predetermined format and/or template, where the product data is used to fill in values and/or interface elements (e.g., drop-down menus, buttons, and/or the like). In some examples, the live auction event may include structured data that is provided to a client-side application, such as a mobile application or desktop application, which displays the live auction event in a user interface.

In some non-limiting embodiments, the countdown timer included in the live auction event may be the same as or similar to countdown timer 104. In some non-limiting embodiments, real-time auction system 102 may generate a plurality of live auction events, each live auction event of the plurality of live auction events including an auction identifier (e.g., a unique auction identifier, an account identifier, and/or the like), a countdown timer (e.g., a unique countdown timer, an independent countdown timer, and/or the like), and product data. For example, each live auction event of the plurality of live auction events may include a unique auction identifier, a unique and/or independent countdown timer, and product data associated with a product different from the other live auction events of the plurality of live auction events.

As a further example, real-time auction system 102 may generate a first live auction event including a first unique auction identifier, a first countdown timer (e.g., countdown timer 104-1), and first product data (e.g., product data associated with a coffee maker). Real-time auction system 102 may generate a second live auction event including a second unique auction identifier, a second countdown timer (e.g., countdown timer 104-2), and second product data (e.g., product data associated with a leather handbag). Real-time auction system 102 may generate subsequent live auction events including subsequent unique identifiers, subsequent countdown timers (e.g., countdown timer 104-3 to countdown timer 104-n), and subsequent product data (e.g., product data associated with subsequent products such as boat covers, storage boxes, furniture, exercise equipment, and/or the like).

As shown in FIG. 2, at step 206, process 200 may include decreasing the price of a product based on a countdown timer. For example, real-time auction system 102 may decrease the price of the product of the live auction event based on countdown timer 104. In some non-limiting embodiments, real-time auction system 102 may decrease the price of the product incrementally based on countdown timer 104. For example, real-time auction system 102 may decrease the price of the product in equal increments for each elapsed second in the countdown timer (e.g., the price decreases by $1 for each elapsed second). In some non-limiting embodiments, real-time auction system 102 may decrease the price of the product in unequal increments for each elapsed unit of time (e.g., each elapsed second, each elapsed 5 seconds, and/or the like). For example, real-time auction system 102 may decrease the price of the product by $1 after 5 seconds have elapsed on countdown timer 104. Furthermore, real-time auction system 102 may decrease the price of the product by $2 after 10 seconds have elapsed on countdown timer 104. Additionally, real-time auction system 102 may decrease the price of the product by $3 after 15 seconds have elapsed on countdown timer 104. It should be appreciated that any conceivable combination of increments of price of the product and increments of units of time on a countdown timer may be contemplated by the subject matter disclosed herein and the combinations of increments of the price of the product and increments of units of time on a countdown timer are not limited to the examples explicitly described herein.

In some non-limiting embodiments, real-time auction system 102 may decrease the price of the product to generate a plurality of subsequent price values. In some non-limiting embodiments, the price of the product may be equal to a subsequent price value of the plurality of subsequent price values. For example, the price of the product may be equal to a subsequent price value of a plurality of subsequent price values after real-time auction system 102 decreases (e.g., incrementally decreases) the price of the product. In some non-limiting embodiments, each subsequent price value of the plurality of subsequent price values may be less than the initial price value. As an example, the price of the product may be equal to an initial price value of $50. Real-time auction system 102 may decrease the price $1 based on each elapsed second of the countdown timer (e.g., countdown timer 104). Real-time auction system 102 may activate the countdown timer to begin decreasing the price of the product. After 1 second elapses on the countdown timer, real-time auction system 102 may decrease the price of the product by $1 from an initial price value of $50 to a first subsequent price value of $49. After another second elapses (e.g., a total of 2 seconds have elapsed) on the countdown timer, real-time auction system 102 may decrease the price of the product by $1 from the first subsequent price value of $49 to a second subsequent price value of $48. After yet another second elapses (e.g., a total of 3 seconds have elapsed) on the countdown timer, real-time auction system 102 may decrease the price of the product by $1 from the second subsequent price value of $48 to a third subsequent price value of $47. The described example may continue as a plurality of seconds elapse on the countdown timer until the price of the product is equal to a subsequent price value of $1.

As shown in FIG. 2, at step 208, process 200 may include receiving a bid order request. For example, real-time auction system 102 may receive a bid order request from user device 106. In some non-limiting embodiments, the bid order request may correspond to the live auction event (e.g., via the auction identifier). In some non-limiting embodiments, the bid order request may be input using one or more selectable options on a user interface, such as input boxes, drop-down menus, buttons, and/or the like. In some non-limiting embodiments, the bid order request may include bid data associated with a bid order for the product (e.g., the product associated with the live auction event). In some non-limiting embodiments, the bid data may include a bid price, a bid quantity, and a bid identifier. In some non-limiting embodiments, the bid identifier may correspond to a user account of a user (e.g., a user and/or user account associated with user device 106).

In non-limiting embodiments, in response to receiving a bid order request, the countdown timer may be paused (e.g., temporarily stopped) for a predetermined period of time (e.g., 30 seconds or the like). In some examples, a visual display of the countdown timer may change in appearance to indicate that the timer is paused. In some examples, one or more additional counters (e.g., a temporary countdown timer) may be started (increasing or decreasing) based on the period of time (e.g., 30 seconds or the like). If the user submitting the bid order request does not purchase the entire quantity available, the remaining quantity of that product may be sold on a “first come, first served” basis during the predetermined time period (e.g., during the 30 seconds while the countdown timer is paused). In some examples, the price per item during the time period may be the same as the bid price submitted in the bid order request. If the time period expires and items in the lot are still unsold, the countdown timer may continue counting down from its paused state until a next bid is received (in response to which the countdown timer may be paused again to provide another time period).

In non-limiting embodiments, different types of bid order requests may be placed by users. For example, a pre-bid may be accepted for an item. For a pre-bid, the lots may be published and made available to potential bidders in advance of the auction (e.g., on the day of the auction and/or a predetermined time prior to the auction). During this pre-auction period, a bidder may place one or more pre-bids into the market. Each pre-bid may be a binding agreement to purchase a quantity of the item being offered for sale at a specific price. A pre-bid may also include an “all or nothing” option that, if selected, the bidder will not accept partial quantities if the order cannot be fulfilled in its entirety. In non-limiting embodiments, a pre-bid may be cancelled or modified at any time prior to being accepted by the auction. In non-limiting embodiments, if multiple pre-bids are entered for the same price, the pre-bid placed first may have priority. A live bid occurs during the auction while the countdown timer is active. In non-limiting embodiments, a live bid may not be cancelled or modified by the bidder once submitted.

As shown in FIG. 2, at step 210, process 200 may include fulfilling the bid order request. For example, real-time auction system 102 may fulfill the bid order request based on the bid data of the bid order request. In some non-limiting embodiments, real-time auction system 102 may fulfill the bid order request based on determining that the bid price of the bid order request matches at least one subsequent price value of the plurality of subsequent price values of the price of the product. For example, real-time auction system 102 may fulfill the bid order request by determining that a bid price of $20 included in the bid order request matches (or is greater than) a subsequent price value of $20. In some non-limiting embodiments, real-time auction system 102 may decrease the quantity of the product to generate a subsequent quantity value when fulfilling the bid order request. In some non-limiting embodiments, when decreasing the quantity of the product to generate the subsequent quantity value, real-time auction system 102 may generate the subsequent quantity value by subtracting the bid quantity from the initial quantity value (e.g., upon fulfilling the bid order request, subsequent quantity value=initial quantity value−bid quantity).

In some non-limiting embodiments, real-time auction system 102 may determine that the bid price of the bid order request matches at least one subsequent price value of the plurality of subsequent price values of the price of the product in real-time (e.g., with respect to real-time auction system 102 decreasing the price of the product to a subsequent price value that is equal to the bid price). For example, real-time auction system 102 may determine that the bid price of $20 included in the bid order request matches the subsequent price value of $20 in real-time with respect to real-time auction system 102 decreasing the price of the product from $21 to $20. In this way, real-time auction system 102 may receive one or more bid order requests including a bid price that is less than the initial price value of the product and/or one or more subsequent price values of the product, and real-time auction system 102 may store (e.g., in database 108) the one or more bid order requests until real-time auction system 102 may fulfill the one or more bid order requests (e.g., by determining that each of the one or more bid prices matches at least one subsequent price value).

In some non-limiting embodiments, real-time auction system 102 may fulfill the bid order request based on decreasing the quantity of the product. In some non-limiting embodiments, real-time auction system 102 may decrease the quantity of the product to generate one or more subsequent quantity values. In some non-limiting embodiments, real-time auction system 102 may decrease the quantity of the product by subtracting the bid quantity included in the bid order request from the initial quantity value to generate the one or more subsequent quantity values. For example, real-time auction system 102 may decrease the quantity of the product by 5 from an initial quantity value of 16 when the bid quantity included in the bid order request is 5 to generate a subsequent quantity value of 9. In some non-limiting embodiments, the one or more subsequent quantity values may be less than the initial quantity value. In some non-limiting embodiments, real-time auction system 102 may decrease the quantity such that the one or more subsequent quantity values is equal to zero (0).

In some non-limiting embodiments, real-time auction system 102 may fulfill the bid order request by processing a transaction. For example, real-time auction system 102 may fulfill the bid order request by processing a transaction including transaction data corresponding to the bid data (e.g., a transaction amount equal to the bid price and/or the like). In some non-limiting embodiments, real-time auction system 102 may process a transaction between a merchant and a user based on the bid identifier included in the bid order request (e.g., a user and/or user account associated with user device 106).

In some non-limiting embodiments, real-time may refer to an instant in time with respect to the occurrence of an event (e.g., real-time with respect to a transaction, real-time with respect to data being generated, real-time with respect to the reading or writing of data, etc.) where a response may occur within a specified time, generally a relatively short time. For example, real-time may refer to an instant in time where a price of a product (e.g., the price of a product of a live auction event of real-time auction system 102) is decreased corresponding to a countdown timer (e.g., an active countdown timer) concurrent with or shortly after (e.g., within milliseconds) receiving and/or fulfilling bid order requests from one or more user accounts of users, where the users are actively participating and/or viewing the live auction event and/or actively viewing the price of the product via a graphical user interface. As a further example, a real-time output may be generated with respect to a real-time input concurrent with or within milliseconds of receiving the real-time input (e.g., a user may submit a bid, and a bid order request may be generated, transmitted, and fulfilled immediately concurrent with or shortly after the bid is submitted by the user).

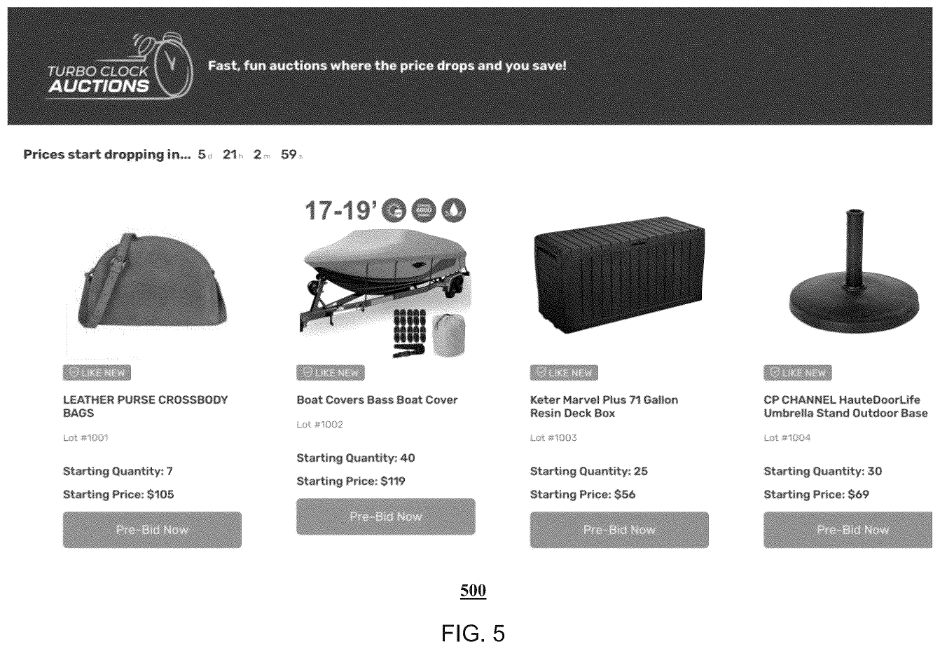

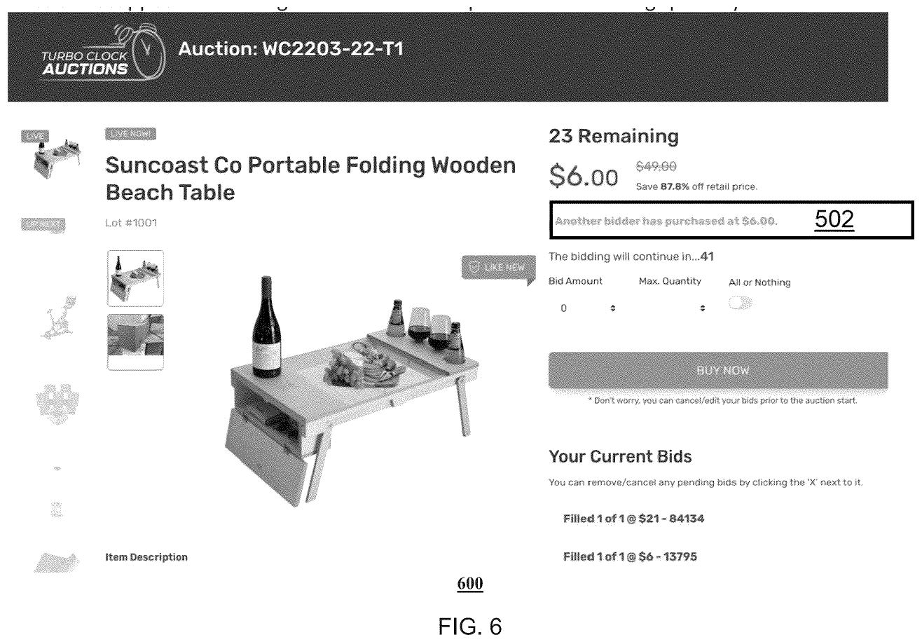

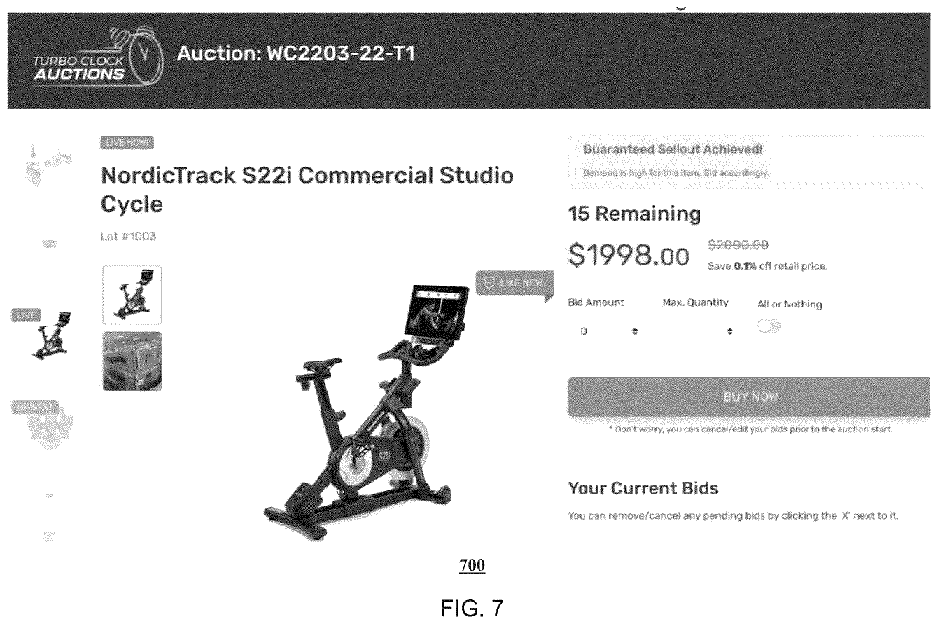

FIGS. 5-7 show graphical user interfaces according to some non-limiting embodiments. FIG. 5 shows an auction preview interface 500 configured to receive pre-bids from users. FIG. 6 shows a live auction event interface 600. As shown, a visual indicator 502 is displayed in response to the countdown timer being paused due to a submitted bid for the current price. In this example, the interface 600 indicates that another bidder has purchased the item for $6, such that other users have a predetermined time period (e.g., 30 seconds) to purchase the item for that price before the countdown timer resumes counting down. FIG. 7 shows an auction event interface 700 for an auction event after it has ended.

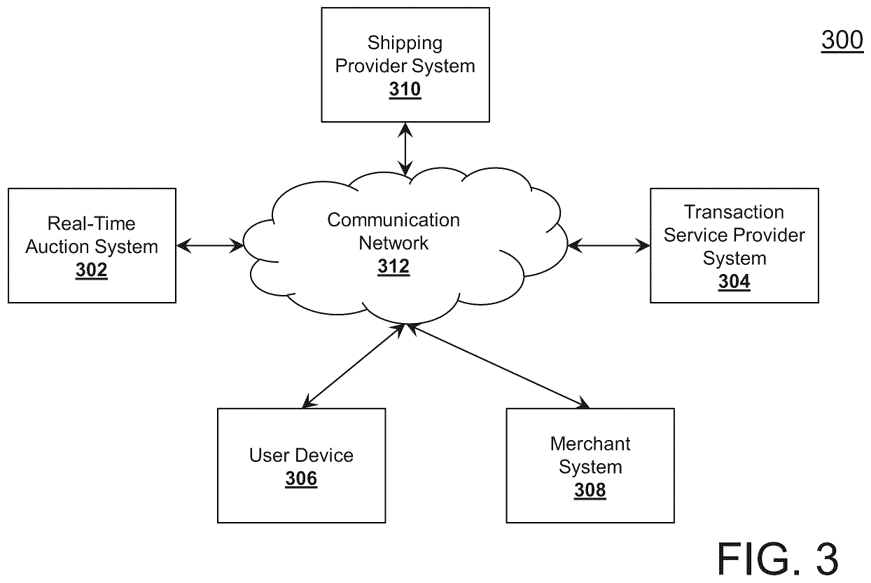

Referring now to FIG. 3, FIG. 3 is a diagram of a non-limiting embodiment or aspect of an exemplary environment 300 in which methods, systems, and/or products, as described herein, may be implemented. As shown in FIG. 3, environment 300 may include real-time auction system 302, transaction service provider system 304, user device 306, merchant system 308, shipping provider system 310, and communication network 312. In some non-limiting embodiments, at least one of each of real-time auction system 102, countdown timer 104, user device 106, and database 108 may be implemented by (e.g., part of) real-time auction system 302. In some non-limiting embodiments, at least one of each of real-time auction system 102, countdown timer 104, user device 106, and database 108 may be implemented by (e.g., part of) another system, another device, another group of systems, or another group of devices, separate from or including real-time auction system 302, such as transaction service provider system 304, merchant system 308, shipping provider system 310, and/or the like.

Real-time auction system 302 may include one or more devices capable of receiving information from and/or communicating information to transaction service provider system 304, user device 306, merchant system 308, and/or shipping provider system 310. For example, real-time auction system 302 may include a computing device, such as a server (e.g., a single server), a group of servers, and/or other like devices. In some non-limiting embodiments, real-time auction system 302 may include at least one processor (e.g., a multi-core processor). In some non-limiting embodiments, real-time auction system 302 may be in communication with a data storage device (e.g., database 108) which may be local or remote to real-time auction system 302. In some non-limiting embodiments, real-time auction system 302 may be capable of receiving information from, storing information in, communicating information to, or searching information stored in the data storage device. In some non-limiting embodiments, real-time auction system 302 may store and/or receive product data (e.g., data associated with a product description, data associated with a product price, data associated with a product quantity, and/or the like), as described herein. In some non-limiting embodiments, real-time auction system 302 may be the same as or similar to real-time auction system 102.

Transaction service provider system 304 may include one or more devices capable of receiving information from and/or communicating information to real-time auction system 302, user device 306, merchant system 308, and/or shipping provider system 310 via communication network 312. For example, transaction service provider system 304 may include a computing device, such as a server (e.g., a transaction processing server), a group of servers, and/or other like devices. In some non-limiting embodiments, transaction service provider system 304 may be associated with a transaction service provider as described herein. In some non-limiting embodiments, transaction service provider system 304 may be in communication with a data storage device (e.g., database 108), which may be local or remote to transaction service provider system 304. In some non-limiting embodiments, transaction service provider system 304 may be capable of receiving information from, storing information in, communicating information to, or searching information stored in the data storage device.

User device 306 may include one or more devices capable of receiving information from and/or communicating information to real-time auction system 302, transaction service provider system 304, merchant system 308, and/or shipping provider system 310 via communication network 312. Additionally or alternatively, each user device 306 may include a device capable of receiving information from and/or communicating information to other user devices 306 via communication network 312, another network (e.g., an ad hoc network, a local network, a private network, a virtual private network, and/or the like), and/or any other suitable communication technique. For example, user device 306 may include a client device and/or the like. In some non-limiting embodiments, user device 306 may or may not be capable of receiving information (e.g., from merchant system 308 or from another user device 306) via a short-range wireless communication connection (e.g., a near-field communication (NFC) communication connection, a radio frequency identification (RFID) communication connection, a Bluetooth® communication connection, a Zigbee® communication connection, and/or the like), and/or communicating information (e.g., to merchant system 308) via a short-range wireless communication connection. In some non-limiting embodiments, user device 306 may be the same as or similar to user device 106.

Merchant system 308 may include one or more devices capable of receiving information from and/or communicating information to real-time auction system 302, transaction service provider system 304, user device 306, and/or shipping provider system 310 via communication network 312. Merchant system 308 may also include a device capable of receiving information from user device 306 via communication network 312, a communication connection (e.g., an NFC communication connection, an RFID communication connection, a Bluetooth® communication connection, a Zigbee® communication connection, and/or the like) with user device 306, and/or the like, and/or communicating information to user device 306 via communication network 312, the communication connection, and/or the like. In some non-limiting embodiments, merchant system 308 may include a computing device, such as a server, a group of servers, a client device, a group of client devices, and/or other like devices. In some non-limiting embodiments, merchant system 308 may be associated with a merchant as described herein. In some non-limiting embodiments, merchant system 308 may include one or more client devices. For example, merchant system 308 may include a client device that allows a merchant to communicate information to real-time auction system 302. In some non-limiting embodiments, merchant system 308 may include one or more devices, such as computers, computer systems, and/or peripheral devices capable of being used by a merchant to conduct a transaction with a user. For example, merchant system 308 may include a server and/or a group of servers as a component of (e.g., part of) real-time auction system 302. Alternatively, merchant system 308 may include a server and/or a group of servers separate from real-time auction system 302.

Shipping provider system 310 may include one or more devices capable of receiving information from and/or communicating information to real-time auction system 302, transaction service provider system 304, user device 306, and/or merchant system 308 via communication network 312. For example, shipping provider system 310 may include a computing device, a server, a group of servers, and/or the like. In some non-limiting embodiments, shipping provider system 310 may be associated with a shipping provider as described herein.

Communication network 312 may include one or more wired and/or wireless networks. For example, communication network 312 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

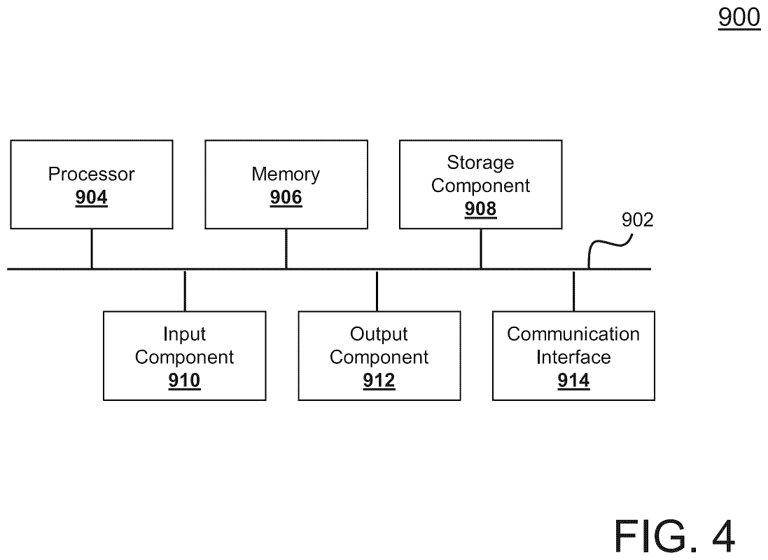

Referring now to FIG. 4, shown is a diagram of example components of a device 900 according to non-limiting embodiments. Device 900 may correspond to at least one of real-time auction system 102, countdown timer 104, user device 106, and/or database 108 in shown FIG. 1 and/or at least one of real-time auction system 302, transaction service provider system 304, user device 306, merchant system 308, and/or shipping provider system 310 shown in FIG. 3, as an example. In some non-limiting embodiments, such systems or devices in FIG. 1 or FIG. 3 may include at least one device 900 and/or at least one component of device 900. The number and arrangement of components shown in FIG. 4 are provided as an example. In some non-limiting embodiments, device 900 may include additional components, fewer components, different components, or differently arranged components than those shown in FIG. 4. Additionally, or alternatively, a set of components (e.g., one or more components) of device 900 may perform one or more functions described as being performed by another set of components of device 900.

As shown in FIG. 4, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, software, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
receiving, with at least one processor, product data associated with a product, the product data comprising a quantity of the product equal to an initial quantity value and a price of the product equal to an initial price value;
generating, with at least one processor, a live auction event associated with the product, the live auction event comprising an auction identifier, a countdown timer, and the product data;
incrementally decreasing, with at least one processor, the price of the product based on the countdown timer, wherein the price of the product is equal to a subsequent price value of a plurality of subsequent price values, wherein each subsequent price value of the plurality of subsequent price values is less than the initial price value;
receiving, with at least one processor, a bid order request comprising bid data associated with a bid order for the product, the bid data comprising a bid price, a bid quantity, and a bid identifier, wherein the bid identifier corresponds to a user account of a user; and
fulfilling, with at least one processor, the bid order request based on the bid data of the bid order request, wherein the bid price matches at least one subsequent price value of the plurality of subsequent price values of the price of the product, and wherein the quantity of the product is decreased to a subsequent quantity value, the subsequent quantity value equal to the initial quantity value minus the bid quantity.

2. The computer-implemented method of claim 1, further comprising:
in response to fulfilling the bid order request, pausing, with at least one processor, the countdown timer associated with the live auction event such that the price of the product does not incrementally decrease and the price of the product is equal to the bid price;
generating, with at least one processor, a temporary countdown timer associated with the at least one subsequent price value and the bid price comprising a time duration; and
activating, with at least one processor, the temporary countdown timer associated with the at least one subsequent price value and the bid price, wherein the price of the product does not incrementally decrease and the price of the product is equal to the bid price while the temporary countdown timer is active.

3. The computer-implemented method of claim 1, further comprising:
terminating, with at least one processor, the live auction event when the quantity of the product is equal to a value of zero or the price of the product is equal to a value of one.

4. The computer-implemented method of claim 2, further comprising:
receiving, with at least one processor, one or more additional bid order requests comprising additional bid prices and additional bid quantities, wherein each additional bid price of the one or more additional bid order requests is equal to the bid price; and
fulfilling, with at least one processor, the one or more additional bid order requests, wherein the subsequent quantity value is decreased by each additional bid quantity of the one or more additional bid order requests.

5. The computer-implemented method of claim 2, further comprising:
in response to the time duration of the temporary countdown timer lapsing, reactivating, with at least one processor, the countdown timer associated with the live auction event such that the price of the product resumes, incrementally decreasing.

6. The computer-implemented method of claim 1, wherein generating the live auction event associated with the product comprises:
generating a pre-auction event associated with the product, the pre-auction event comprising the auction identifier and the product data; and
publishing the pre-auction event associated with the product, wherein the pre-auction event is accessible to the user account of the user via a web-based user interface.

7. The computer-implemented method of claim 4, further comprising:
terminating the live auction event when the quantity of the product is equal to a value of zero.

8. The computer-implemented method of claim 1, wherein the initial price value is a retail price associated with the product.

9. The computer-implemented method of claim 4, further comprising:
generating, with at least one processor, invoice data associated with one or more invoices, wherein the one or more invoices correspond to the bid order request and one or more corresponding additional bid order requests that are fulfilled; and
transmitting, with at least one processor, each invoice of the one or more invoices to the user account of the user based on the bid identifier of the bid order request and the corresponding one or more additional bid order requests that are fulfilled.

10. The computer-implemented method of claim 1, wherein fulfilling the bid order request comprises:
determining that the bid price of the bid order request matches the at least one subsequent price value of the plurality of subsequent price values of the price of the product; and
transmitting a confirmation message to the user account of the user indicating that the bid order request corresponding to the user account of the user has been fulfilled.

11. The computer-implemented method of claim 1, wherein the live auction event is conducted via a graphical user interface, wherein the auction identifier, the countdown timer, and the product data are displayed via the graphical user interface.

12. A system comprising:
at least one processor programmed or configured to:
receive product data associated with a product, the product data comprising a quantity of the product equal to an initial quantity value and a price of the product equal to an initial price value;
generate a live auction event associated with the product, the live auction event comprising an auction identifier, a countdown timer, and the product data;
incrementally decrease the price of the product based on the countdown timer, wherein the price of the product is equal to a subsequent price value of a plurality of subsequent price values, wherein each subsequent price value of the plurality of subsequent price values is less than the initial price value;
receive a bid order request comprising bid data associated with a bid order for the product, the bid data comprising a bid price, a bid quantity, and a bid identifier, wherein the bid identifier corresponds to a user account of a user; and
fulfill the bid order request based on the bid data of the bid order request, wherein the bid price matches at least one subsequent price value of the plurality of subsequent price values of the price of the product, and wherein the quantity of the product is decreased to a subsequent quantity value, the subsequent quantity value equal to the initial quantity value minus the bid quantity.

13. The system of claim 12, wherein the at least one processor is further programmed or configured to:
in response to fulfilling the bid order request, pause the countdown timer associated with the live auction event such that the price of the product does not incrementally decrease and the price of the product is equal to the bid price;
generate a temporary countdown timer associated with the at least one subsequent price value and the bid price comprising a time duration; and
activate the temporary countdown timer associated with the at least one subsequent price value and the bid price, wherein the price of the product does not incrementally decrease and the price of the product is equal to the bid price while the temporary countdown timer is active.

14. The system of claim 12, wherein the at least one processor is further programmed or configured to:
terminate the live auction event when the quantity of the product is equal to a value of zero or the price of the product is equal to a value of one.

15. The system of claim 12, wherein the at least one processor is further programmed or configured to:
receive one or more additional bid order requests comprising additional bid prices and additional bid quantities, wherein each additional bid price of the one or more additional bid order requests is equal to the bid price; and
fulfill the one or more additional bid order requests, wherein the subsequent quantity value is decreased by each additional bid quantity of the one or more additional bid order requests.

16. The system of claim 13, wherein the at least one processor is further programmed or configured to:
in response to the time duration of the temporary countdown timer lapsing, reactivating, with at least one processor, the countdown timer associated with the live auction event such that the price of the product resumes, incrementally decreasing.

17. The system of claim 12, wherein generating the live auction event associated with the product comprises:
generate a pre-auction event associated with the product, the pre-auction event comprising the auction identifier and the product data; and
publish the pre-auction event associated with the product, wherein the pre-auction event is accessible to the user account of the user via a web-based user interface.

18. The system of claim 12, wherein the at least one processor is further programmed or configured to:
terminate the live auction event when the quantity of the product is equal to a value of zero.

19. A computer program product comprising at least one non-transitory computer-readable medium including program instructions that, when executed by at least one processor, cause the at least one processor to:
receive product data associated with a product, the product data comprising a quantity of the product equal to an initial quantity value and a price of the product equal to an initial price value;
generate a live auction event associated with the product, the live auction event comprising an auction identifier, a countdown timer, and the product data;
incrementally decrease the price of the product based on the countdown timer, wherein the price of the product is equal to a subsequent price value of a plurality of subsequent price values, wherein each subsequent price value of the plurality of subsequent price values is less than the initial price value;
receive a bid order request comprising bid data associated with a bid order for the product, the bid data comprising a bid price, a bid quantity, and a bid identifier, wherein the bid identifier corresponds to a user account of a user; and
fulfill the bid order request based on the bid data of the bid order request, wherein the bid price matches at least one subsequent price value of the plurality of subsequent price values of the price of the product, and wherein the quantity of the product is decreased to a subsequent quantity value, the subsequent quantity value equal to the initial quantity value minus the bid quantity.
